(19) United States
(12) Patent Application Publication
(10) Pub. No.: US 2002/0035204 A1
(43) Pub. Date: Mar. 21, 2002

(54) Sealing strips, a method for manufacturing and for connecting sealing strips to a sub-surface or to themselves, as well as the use of sealing strips in the building trade

(75) Inventors: Richard Durham, Uetlikon am See (CH); Otto Gortz, Fehraltdorf (CH)

Correspondence Address: SHOEMAKER AND MATTARE, LTD., Suite 1203 Crystal Plaza Bldg. 1, 2001 Jefferson Davis Highway, P.O. Box 2286, Arlington, VA, 22202-0286, US

(73) Assignee: Huber + Suhner AG, Tumbelenstrasse (CH)

(21) Appl. No.: 09/908,916

(22) Filed: Jul. 20, 2001

(30) Foreign Application Priority Data
Jul. 25, 2000 (EP) 00115907.8

(51) Int. Cl. C08F 8/00

(52) U.S. Cl. 525/107

(57) ABSTRACT

The invention relates to sealing strips, to methods for manufacturing and connecting sealing strips, to the use of the sealing strips in the building trade as joint sealings, facade strips and roofing sheets. The sealing strips consist of polymer materials and contain at least one thermoplastic polymer with at least one reaction-capable epoxy function so that a connection of the sealing strip to the sub-surface or to itself is possible by adhesing or welding.

The present invention relates to sealing strips, it relates to methods for manufacturing and connecting such sealing strips to a sub-surface or to themselves, further it relates to the use of such sealing strips in the building trade, in particular as joint sealings, facade strips and roofing sheets, according to the definition of the patent claims.

Sealing strips are used in the building trade for sealing small but also large surface regions such as joints, roofs, facades, etc. With them for example, construction and expansion joints, working joints, movement joints, connections, concreting stages, fractures, openings, point adhesings, bonding locations, error locations, etc. are sealingly bridged. In particular they are applied with expansion joints of building interiors and at the same time are subjected to positive and negative water pressures.

Known sealing strips consist of materials such as for example polyvinyl chloride (PVC), polyethylene (PE), polypropylene as well as other polymers or their copoylmers or terpolymers. The connection to the sub-surface or to itself is effected by adhesing and/or welding. For example the adhesing is effected with epoxy adhesives, silicon sealing masses, etc. and the welding by way of hot air welding. Also a joining of piles of sealing strips is effected by way of such an adhesing or welding.

Sealing strips are applied unsupported or supported, as expansion regions. For this as a rule they are pre-treated. For example sealing strips are previously surface activated with a bonding agent (primer), or by way of corona or plasma treatment, in order thus to permit a connection to the sub-surface. Or sealing strips are provided in regions with a substrate layer via which the connection to the sub-surface is created. For example the substrate layers in the regions of the lateral edges of the sealing strips in regions are attached as textile strips (edge strips). As a rule only previously activated surface regions of substrateless sealing strips or sealing strips provided with substrate layers only in regions may be securely and permanently connected to the sub-surface or to themselves. The connection of non-activated surface regions of the sealing strips or unsupported regions of the sealing strips to the sub-surface or to themselves is mostly significantly worse, insecure and not permanent.

Substrate-free sealing strips are often only capable of storage under certain conditions or they are rolled up distanced from one another via separating layers in order thus to prevent a mutual inadvertent welding of layers lying on one another. The rolling-up of the sealing strips with separating layers is complicated, and the separating layers must be removed before use.

Furthermore there is an increasing requirement for ecologically harmless building products with regard to their pollutant-free waste disposal.

The quality of the sealing is heavily dependent on the nature and structure of the sub-surface, as well as on the functionality of the applied polymers.

As a rule the coming-together of several joints is solved by welding several layers of sealing strips applied over one another. With the use of substrateless sealing strips a prior activation of all surface regions turns out to be difficult. For example by way of such a welding there arise new, non-surface-activated regions which are accordingly poorly, unsecurely and not permanently connectable to the sub-surface or to themselves.

Also the application of supported sealing strips on joints is difficult since the connection of the unsupported regions of the sealing strips to the sub-surface is as a rule significantly worse than that of the support layers. There is therefore the danger of an insufficient connection leading to a case of damage.

Such solutions in several working steps are disadvantageous. They render the manufacture of sealing strips complicated and expensive. They also render the use of the sealing strips complicated and time-intensive. Finally they represent a potential safety risk.

It is the object of the invention to alleviate the previously mentioned disadvantages.

In particular the sealing strip is to be connectable to a sub-surface or to itself without prior surface activation, in particular without a primer. A further object lies in selecting the composition of the sealing strip and a method for its manufacture such that the sealing strip is suitable for exposure to drinking water and achieves a drinking water approval. The invention is to make available sealing strips which are simple and inexpensive in manufacture and storage as well as being simple, quick and safe in use, and which prove to be compatible with tried and tested techniques. The sealing strips are to be accepted by the market and simple to be disposed of. Furthermore the invention is to make available a method for manufacturing and for connecting sealing strips and it is to make available a use of the sealing strips in the building trade, joint sealings, facade strips and roofing sheets.

This object is achieved by the invention defined in the patent claims.

The invention achieves this object in that it makes available sealing strips which apart from the material properties for forming expansion zone regions contain at least one polymer with at least one epoxy function for the adhesive and/or welding connection to the sub-surface or to themselves. The adhesing is effected in particular with epoxy adhesives. Furthermore silicon sealing masses may also be used. The welding is effected at high temperatures, in particular by hot-air welding. By way of a direct connection to the sub-surface, such as e.g. concrete or to itself, additional working steps such as the prior deactivation of all surface regions or the provision in regions of one or more substrate layers is done away with. The use of sealing strips is accordingly simplified. Also these sealing strips do not represent any potential safety risk, in the case for example that the primer for a surface treatment had been forgotten or the connection by way of substrate layers is not tight.

The sealing strips may be connected to the sub-surface directly and independently of the regions, for example by adhesing. They have a very good weldability to themselves, so that with the coming-together of several joints, secure and permanent connections of layers applied over one another may be quickly created in a simple way and manner.

The compositions forming the sealing strip according to the invention are selected such that with the storage a mutual welding of rolled-up layers of sealing strips lying on one another does not occur, separating layers are no longer required and the manufacture is simplified. The sealing strip according to the invention on its surface does not contain cross-linkable groups which on storage in particular with an increased temperature of the surroundings would lead to a cross-linking reaction (chemical welding). Thermoplastic welding which is based on diffusion of polymer chains on the other hand may be carried out at or above the softening point according to the invention.

The sealing strip for use in the building trade, consisting of a composition containing thermoplastic polymers is characterised in that the composition comprises at least one epoxy-functional polymer in such a quantity that the sealing strip after adhesing with an epoxy adhesive has an adhesive force measured according to DIN 18555 of larger or equal to 2 N/mm² and/or a peel force measured according to DIN 53357 of larger than or equal to 50 N/cm.

In a preferred embodiment form the peel force of the sealing strip achieved after adhesing with an epoxy adhesive without prior surface activation is 70 N/cm.

Part of the present invention is furthermore a method for manufacturing a sealing strip for the use in the building trade, containing the following steps

preparing a composition containing at least one thermoplastic polymer and at least one polymer containing epoxy groups;

selecting the thermoplastic polymer or the mixture of thermoplastic polymers in particular in a manner such that the tensile trength according to ISO 527 of a sealing strip consisting of one of these polymers in the direction of loading is greater or equal to 6 MPa;

adding the polymer containing the epoxy groups in such a quantity that the sealing strip after adhesing with an epoxy adhesive has an adhesive force measured according to DIN 18555 of larger or equal to 2 N/mm² and/or a peel force measured according to DIN of larger or equal to 50 N/cm, preferably larger or equal to 70 N/cm;

conveying the composition into a homogeneous condition;

forming the homogeneous composition into a sealing strip.

The term “homogeneous” is to indicate a macroscopically uniform composition according to Römpp, Chemie Lexikon, Georg Thieme publishing house, Stuttgart, 9th edition, p. 1844.

The forming into a sealing strip is preferably achieved by extruding, techniques such as calendering are however likewise applicable.

The sealing strips may in a preferred embodiment form also be constructed of several layers with or without reinforcement. At least one of the layers corresponds in its composition to the composition of the sealing strip according to the invention.

As an epoxy adhesive commercially available 2-component adhesives such as Rivalcoll Concresive 1402 of MBT are applicable.

In the following the invention is explained in detail by way of three tables:

Table 1 indicates a recipe of an exemplary composition of sealing strips,

Table 2 is a list of polymers taking part in the recipe of a first exemplary composition of sealing strips according to Table 1, ordered according to their functionality and

Table 3 indicates recipes of further exemplary compositions of sealing strips:

| | | | part |
|---|---|---|---|
| | | | share in |
| | | | % by |
| Polymer/additive | desicription | name | weigth |
| Paraloid KM334 ER | acrylate | p(butylacrylate/methyl- | 10 |
| | impact | methacrylate) | |
| | modifier | p(BA/MMA) | |
| | | calcium carbanote ˜2% | |
| Lotader AX 8840 | E-GMA | copolymer | 18 |
| | | ethylene + glycidyl | |
| | | methacrylate 8% | |
| Engage 8480 VLDPE | Metallocene | copolymer | 10 |
| | VLDPE | ethylene + octene-1 | |
| Lotader AX 8900 | E-CO-GMA | terpolymer | 40 |
| | | ethylene/methyl | |
| | | acrylate 24% | |
| | | glycidyl methacrylate | |
| | | 7% | |
| Elvaloy AM | E-nBA- | terpolymer | 0 |
| | GMA | ethylene/methyl | |
| | | acrylate 9% | |
| | | glycidyl methacrylate | |
| | | 5.25% | |
| Lotryl 9MA02 | E-MA | copolymer | 0 |
| | | ethylene/methyl | |
| | | acrylate 24% | |
| Evatane 24-03 | E-VA | copolymer | 20 |
| | | ethylene/vinyl acetate | |
| | | 9% VA | |
| Irganox 1010 | stabiliser | pentaerythritol | 0.4 |
| | | tetrakis [3-(3,5-di- | |
| | | tert-butyl-4-hydroxy- | |
| | | phenyl)proprionate] | |
| Naugard XLI | stabiliser | 2,2-oxamido bis-[ethyl | 0.4 |
| | | 3-(3.5-di-tert-butyl-4 | |
| | | hydroxy- | |
| | | phenyl)proprionate] | |
| Tinuvin 783 FDL | (UV- | poly[[6-[(1,1,3,3- | 0.2 |
| | stabiliser A) | tetramethylbutyl)- | |
| | | Amino]-1,3,5-triazine- | |
| | | 2,4-diyl] [2,2,6,6- | |
| | | tetramethyl-4- | |
| | | piperidinyl)iminol]- | |
| | | 1,6-hexandiyl[2,2,6,6- | |
| | | tetramethyl-4- | |
| | (UV- | piperidinyl)iminol]],Bu | |
| | stabiliser B) | tandioic acid, dimethyl | |
| | | ester, polymer with 4- | |
| | | hydroxy-2,2,6,6,- | |
| | | tetramethyl-1- | |
| | | piperidine ethanol | |
| coulor batch | disperbatch | EVA, titanium dioxide, | 1 |
| | grey | soot | |

TABLE 2
List of the polymers taking part in the Recipe 1 of an
exemplary composition of sealing strips according to
TABLE 1, ordered according to their functionality:

| | | | part |
|---|---|---|---|
| | | | share in |
| | | | % by |
| Polymere/additive | description | functionality | weight |
| Paraloid KM334 ER | acrylate | epoxide adhesing | 10 |
| (polymer) | impact | | |
| | modifier | | |
| Lotader AX 8840 | E-GMA | mechanics | 18 |
| (polymer) | | | |
| Engage 8480 VLDPE | Metallocen | softness, mechanics | 10 |
| | VLDPE | | |
| Lotader AX 8900 | E-MA-GMA | epoxide adhesing, | 40 |
| (polymer) | | softness, hot air | |
| | | welding | |
| Elvaloy AM | E-nBA-GMA | epoxide adhesing, | 0 |
| (polymer) | | softness, hot air | |
| | | adhesing | |
| Lotryl 9MA02 | E-MA | mechnics | 0 |
| (polymer) | | | |
| Evatene 24-03 | E-VA | softness, hot air | 20 |
| (polymer) | | adhesing | |
| various | stabiliser | heat and UV stability | 1 |
| stabilisers | | | |
| (additive) | | | |
| colour batch | disper batch | colour | 1 |
| (additive) | grey | | |

TABLE 3
list of recipes of exemplary composition of sealing
strips (2 mm thickness):

| | part share | part share | part share | part share |
|---|---|---|---|---|
| | % by | % by | % by | % by |
| | weight | weight | weight | weight |
| Polymer/additive | Recipe 1 | Recipe 2 | Recipe 3 | Recipe 4 |
| Paraloid KM334 | 10 | 10 | 10 | 10 |
| ERE | | | | |
| Lotader AX 8840 | 18 | 18 | 18 | 0 |
| Engage 8480 VLDPE | 10 | 10 | 10 | 10 |
| Lotader AX 8900 | 40 | 0 | 0 | 0 |
| Elvaloy AM | 0 | 40 | 0 | 0 |
| Lotryl 9MA02 | 0 | 0 | 0 | 58 |
| Evatene 24-03 | 20 | 20 | 60 | 20 |
| various stabilisers | 1 | 1 | 1 | 1 |
| colour batch | 1 | 1 | 1 | 1 |
| adhesing force | >2.25 | >2.75 | >0.6 | >0.5 |
| (N/mm²) | | | | |
| peeling force | >70 | >70 | 23 | 12 |
| (N/cm) | | | | |

The definition of the term thermoplastic polymers is effected according to Römpp, Chemie Lexikon, Georg Thieme publishing house, Stuttgart 9th edition, p. 4570. It is the case of polymers which have or form no cross-linkings to other polymers.

Thermoplastic polymers which are suitable for the use in sealing strips have been known to the man skilled in the art for a long time and are extensively described in literature. Polar thermoplasts such as for example butyl acrylate/methyl methacrylate, ethylene-vinyl acetate or other methyl acrylate-containing copolymers as well as apolar thermoplasts such as e.g. copolymers of ethylene with octene, EPDM, etc. are suitable.

The man skilled in the art by way of the mixture of “hard” thermoplastic polymers such as e.g. LDPE (low density polyethylene) and soft thermoplastic polymers such as e.g. ethylene vinyl acetate achieves the setting of the properties demanded for the sealing strips. These must on the one hand be resistant to environmental loading (humidity, cold, heat, pH fluctuations, harmful substances or substances diffusing from the sub-surface or layers), and on the other hand they must however also be pliant, flexible and ductile. From a certain point of view, on the part of the polymer selection these are conflicting properties; optimised properties with regard to the properties of the sealing strip may when required by achieved in particular by polymer mixings.

The polymers used for the sealing strip according to the invention accordingly contain no cross-linkable, functional groups. They contain no halogen and/or sulphur groupings. The sealing strip of the present invention is free of heavy metals as well as free of halogen and bitumen. The sealing strip thus permits an ecologically safe waste disposal as well as also the possibility of recycling or return into the production process. In particular with the waste disposal by way of incineration there are released no halogen-hydrogen compounds.

In a preferred embodiment form of the present invention the tensile strength according to ISO 527 is at least 6 MPa. Furthermore the secant module according to ISO 527 of the sealing strip according to the invention lies preferably in the region between 1 and 2% extension, smaller or equal to 25 Mpa.

In a preferred embodiment form the thermoplastic polymers have a melting point of at least 450° C., preferred in the region of 50-150° C. and even more preferred of 60-130° C.

Conventional substrate-free sealing strips are not adhesable with commercially available two-component epoxy adhesives without a prior surface activation, for example not without a prior application of a primer. It has been surprisingly shown that by way of the admixture of at least one polymer containing epoxy groups to at least one thermoplastic polymer or to mixtures of thermoplastic polymers one may do without a prior application of a primer. Thus a “surface-activation-free” adhesing of the sealing strips according to the invention to the sub-surface or to themselves is achieved by commercially available epoxy adhesives. The adhesing is however possible also by way of further adhesing compositions containing cross-linkable groups, in particular with this silicon sealing masses, in particlar when they are based on silanols, have been shown to be suitable.

The part share of the epoxy-functional polymer in the composition forming the sealing strip lies in the region of 20 and 70% by weight, preferably between 30 and 60% by weight and even more preferred between 40 and 50% by weight with respect to the total weight of the composition. Disregarding the part share of auxiliary agents and additives up to 5% by weight with respect to the total weight of the composition, the weight part share of the thermoplastic polymer or mixtures of thermoplastic polymers forms the difference to one hundred. Higher part shares of polymers containing epoxy groups result in insufficient adhesing and peel forces (see for example Recipe 3 and 4).

The weight part share of the epoxy groups lies with respect to the total weight of the composition preferably in the region of 2 to 12% by weight, preferred between 3 and 10% by weight and even more preferred between 4 and 6% by weight.

The term epoxy groups is to be understood as a bridging of one or more C—C bonding/s by the grouping —O—. Such functional epoxide groups are polar. As polymers containing epoxy groups preferably copolymers of hydrocarbons such as ethylene and glycidyl methacrylates are used but also terpolymers for example of ethylene, methyl acrylate and glycidyl methacrylate.

Although with respect to the reactivity of the epoxy group, relatively chemically inert polymers are applied, it may not be ruled out that a certain percentage of the epoxy groups during the forming of the sealing strip, in particular during the extrusion, for example react with the air humidity into hydroxyl groups. In the sealing strip there are therefore present unreacted epoxide groups as well as reacted epoxy groups (and thus epoxy groups having become epoxy functions). In the course of the present invention epoxy functions are to be understood as epoxy groups unreacted in the sealing strip as well as compounds arising and derivable from epoxy groups such as e.g. the hydroxyl groups arising with the reaction with air humidity.

Furthermore in the present invention the term polymer containing epoxy groups is selected as a description of the starting material since for the starting material one may proceed from essentially unreacted epoxy groups. The term epoxy-functional polymers is to indicate the condition of the polymers, containing the epoxy groups, applied or present in the sealing strip.

The polymers containing the epoxy groups have preferably likewise thermoplastic properties. The melting points of these preferably applied polymers lie in particular in the region between 50° C. to 130° C., preferred between 55° C. and 120° C. and even more preferred between 60° C. and 110° C.

With thermoplastic polymers with an epoxy group it is the case for example of commercially available polymers or polmer mixtures such as the polymers Lotader AX8840 or Lotader AX8900 or Elvaloy AM, containing the “building block” glycidyl methacrylate. The monomer glycidyl methacrylate is copolymerised with further monomers, so that a long-chained polymer containing epoxy groups arises. This also after long exposure times does not wash out of the sealing strips. By way of this the sealing strips fullfill the requirements for a drinking water authorisation (measured according to the regulations of the Swiss foodstuff book, chapter 48, “Bedarfsgegenstande aus Kunstoff” (used objects of plastic). Possible remains of monomeric glycidyl methacrylate are removed from the composition to be extruded during the extrusion under the selected vacuum conditions before the manufacture of the sealing strip. Polymers may also be used which have monomers containing functional epoxy groups other than gylcidyl methacrylate. The man skilled in the art with the knowledge of the present invention has many possibilities with respect to this of using polymers with at least one epoxy group for the manufacture of sealing strips as long as the sealing strips fullfill the drinking water authorisation conditions.

The polymer Paraloid KM334 ER, which contains p(butylacrylate/methyl methacrylate) is preferably used; it improves the adhesability of Lotader AX8840 or Lotader AX8900 or Elvaloy AM. The addition of Paraloid KM334 ER also ensures more adhesion of the sealing strips on the sub-surface or in contact with itself.

The polymer Paraloid KM334 ER, Evatane 24-03 and glycidyl methacrylate have a high polarity and effect a high surface tension of the sealing strips. For connecting to the sub-surface the sealing strips therefore no longer, as with the state of the art, need to be surface-activated. In particular this high polarity is produced free of halogen so that a simple recycling or a simple return into the production process is possible.

The polymers with at least one epoxy function may be matched in mixing ratios. According to Recipe 1 their part share on the sealing strips is for example 18% Lotader AX 8840 and 40% Lotader AX 8900. According to Recipe 2 there part share on the sealing strips is for example 18% Lotader AX 8840 and 40% Elvaloy AM.

In particular the polymers Lotader 88400 or Engage 8480 VLDPE reinforce the mechanical stability and strength of the sealing strips. According to DIN 53504 the tear strength of the sealing strips according to the invention should be larger than 6 MPa and the tear extension should be larger than 60%. In particular according to DIN 53363 the further tear resistance should be larger than 600 N/cm. According to DIN 18555 the adhesive force should be larger than 2 N/mm² and/or according to DIN 53357 the peel force larger than 50 N/cm. Table 3 lists the holding force as a vertical adhesion tensile test (VATT) and the peel force for various recipes. From this it is evident that the adhesive force or peel force for Recipe 3 and 4 are insufficient. This is based on the fact that in Recipe 4 there is contained no polymer with at least one epoxy function (0% part share epoxy groups) and that in Recipe 3 with 1.4% applied epoxy groups with respect to the weight of the composition a too low a part share of epoxy functions is present in the sealing strip. These details are by way of example and are not limiting. With the knowledge of the present invention the man skilled in the art is free to use other polymers in sealing strips in order to obtain a direct, region-independent, permanent and secure connection to a subsurface or to themselves.

The sealing strips are manufactured on commercially available machines. The sealing strips are manufactured in a single method step as an endless product or by way of extrusion and for example rolled up in widths between 10 cm and 300 cm as well as in thicknesses of 0.4 mm to 3 mm onto rollers. Hydroxyl groups arisen on the surface of the sealing strip could with respect to the adhesing with epoxy adhesive lead to an advantageous reaction (cross-linking) with the epoxy groups in the adhesive and additionally increase the values of the adhesive and peel force.

In order to suppress the reaction of all epoxy groups within the sealing strip as much as possible the extrusion is preferably carried out under a vacuum of less than or equal to 400 mbar. The mass temperature in the extruder or calender lies in a region between 159 and 220° C., preferably in a region of 170° C. to 200° C. and even more preferred at 190° C., in particular during the extruding or calendering. Optionally there is possible the application of an expanding agent in order to obtain foamed sealing strips. At the same time to the man skilled in the art with the knowledge of the present invention there is available a great variety of possibilities of variation. Thus of course larger or smaller roller widths are possible, also thicker or thinner roller thicknesses are posssible.

The sealing strips may be applied in the building trade in a variety of ways: For example they serve as joint sealings, fassade strips or roof strips. The application is exceedingly simple and may be varied in a variety of ways without a safety risk. For example the sealing strips from the roller may be directly applied on joints without substrate. They may joined for example by way of epoxy adhesive and/or for example by way of hot-air welding or silicon sealing masses. The sealing strips may be cut in all widths between 10 cm and 200 cm. Basically of course a supported application of the sealing strips is possible. For example they are used together with substrate layers in regions as with textile edge strips or together with region-independent substrate layers as with continuous strips. Also here to the man skilled in the art with the knowledge of the present invention there are possible a variety of possibilities of variation. Thus of course a cutting of the sealing strips into smaller or larger widths is possible.

1. A sealing strip for use in the building trade, comprising a composition containing thermoplastic polymers, and at least one epoxy-functional polymer.

2. A sealing strip according to claim 1, wherein the epoxy-functional polymer is selected from the group consisting of polymers containing glycidyl methacrylate.

3. A sealing strip according to claim 2, wherein the epoxy-functional polymer is selected from the group consisting of copolymers of ethylene and glycidyl methacrylate and terpolymers of ethylene, methyl acrylate and glycidyl methacrylate.

4. A sealing strip according to claim 3, wherein the content of glycidyl methacrylate is present in a range of 3 to 15% by weight, preferred in a range of 4 to 12% by weight and even more preferred in a range of 5 to 8% by weight with respect to the weight of the polymer containing the glycidyl methacrylate.

5. A sealing strip according to claim 1, wherein the epoxy-functional groups in the composition are present in a region of 2 to 12% by weight, preferably in a region of 3 to 10% by weight and even more preferred in a region of 4 to 6% by weight with respect to the total weight of the composition.

6. A sealing strip according to claim 1, wherein the thermoplastic polymer or the mixture of thermoplastic polymers is selected in a manner such that the tensile strength measured according to ISO 527 of a sealing strip consisting of these polymers, in the direction of loading, is greater or equal to 6 MPa.

7. A sealing strip according to claim 1, wherein the composition is homogeneous.

8. A sealing strip according to claim 1, wherein the tensile strength measured according to ISO 527 of the sealing strip in the direction of loading is larger or equal to 6 MPa.

9. A sealing strip according to claim 1, wherein the sealing strip is free from halogen, bitumen and heavy metal.

10. A sealing strip according to claim 1, the strip consisting of several layers wherein at least one of the layers has of a composition according to claim 1.

11. A method for manufacturing a sealing strip for use in the building trade, comprising the steps of
preparing a composition containing at least one thermoplastic polymer and at least one polymer containing epoxy groups;
selecting the thermoplastic polymer or the mixture of thermoplastic polymers in particular in a manner such that the tensile strength according to ISO 527 of a sealing strip consisting of one of these polymers, in the direction of loading, is greater or equal to 6 MPa;
adding the polymer containing the epoxy groups in such a quantity that the sealing strips after adhesing with an epoxy adhesive have an adhesive force measured according to DIN 18555 of larger or equal to 2 N/mm² and/or a peel force measured according to DIN of larger or equal to 50 N/cm;
conveying the composition into a homogeneous condition;
forming the homogeneous composition into a sealing strip.

12. A method according to claim 11, wherein the forming of the sealing strip is effected by extrusion or calendering and wherein the conveying of the composition into the homogeneous condition is effected in an extruder or calender.

13. A method according to claim 12, wherein the extrusion and in particular the conveying into the homogeneous condition is effected under a vacuum smaller or equal to 400 mbar.

14. A method according to claim 10, wherein the temperature of the composition in the extruder, in particular during the extrusion lies in a range of 150° C. to 220° C., in particular in a region of 170° C. to 200° C. and preferably around 190° C.

15. A method according to claim 10 to 14, wherein the sealing strips are manufactured in a single step as an endless product in a width between 10 cm and 300 cm as well as a thickness from 0.4 to 3 mm.

16. The use of a composition containing at least one polymer with at least one epoxy group and at least one further thermoplastic polymer for manufacturing sealing strips for the building trade.

17. The use of at least one polymer containing epoxy groups in a sealing strip for achieving an adhesive force (according to DIN 18555) of at least 2 N/mm² after adhesing with epoxy adhesives and/or for achieving weldability to at least one further sealing strip of the same or similar softening point.

18. A method for connecting sealing strips of thermoplastic materials to a sub-surface, in particular concrete, wherein the sealing strips contain at least one polymer with at least one epoxy function and are connected to the sub-surface or to themselves by adhesing with an epoxy adhesive or welding.

19. A sealing strip for use in the building trade, comprising a composition containing thermoplastic polymers, wherein the composition contains at least one epoxy-functional polymer in such a quantity that the sealing strip after adhesing with an epoxy adhesive has an adhesive force measured according to DIN 18555 of larger or equal to 2 N/mm² and/or a peel force measured according to DIN 53357 of greater of equal to 50 N/cm.
